(19) United States
(12) Patent Application Publication
(10) Pub. No.: US 2017/0255908 A1
(43) Pub. Date: Sep. 7, 2017

(54) SYSTEM AND METHOD FOR ELECTRONIC PAYMENT

(71) Applicants: Ruan & Riana Familie Trust, Cape Town (ZA); Jeremiah 33 Family Trust, Cape Town (ZA)

(72) Inventors: Jozef Philippus Wolhuter JOUBERT, Cape Town (ZA); Ruan MALAN, Cape Town (ZA)

(21) Appl. No.: 15/507,078

(22) PCT Filed: Aug. 28, 2015
(86) PCT No.: PCT/IB2015/056537

§ 371 Date: Feb. 27, 2017

(30) Foreign Application Priority Data
Aug. 29, 2014 (ZA) 2014/06362

(51) Int. Cl. G06Q 20/02; G06Q 20/42; G06Q 20/40; G06Q 20/32; G06Q 20/38

(52) U.S. Cl. CPC G06Q 20/02; G06Q 20/3274; G06Q 20/382; G06Q 20/385; G06Q 20/40; G06Q 20/425; G06Q 20/322

(57) ABSTRACT

A system and method for conducting electronic payment transactions between transaction initiators and transaction responders is disclosed. The system comprises a server system in communication with transactional infrastructure of the transaction initiators and transaction responders and enables a transaction initiator to initiate a transaction by sending a transaction initiation request to the server system, which in turn generates a first, responder independent token representing the transaction. The first token is then stored and communicated to the transactional infrastructure of the transaction initiator from where it is communicated to the transaction responder. The transaction responder in turn transmits a response request including the first token to the server system via an independent channel, where the token is extracted and compared to originally generated token. If the tokens are found to correspond the transaction is completed between the initiator and responder.

### CROSS-REFERENCE(S) TO RELATED APPLICATIONS

This application claims priority to South African provisional patent application number 2014/06362 filed on 29 Aug. 2014, which is incorporated by reference herein.

### FIELD OF THE INVENTION

The technology described in this application relates to electronic payments, particularly, but not exclusively, electronic payments involving mobile communication devices.

### BACKGROUND TO THE INVENTION

Electronic, cashless payments for goods and services have become the norm, rather than the exception and are in many instances the preferred way of transacting. Consumers are also increasingly conducting electronic payments using, in one way or another, functionality provided by electronic devices, in particular mobile communication and/or computing devices, be it communication devices such as smart or so-called older generation “feature” phones, personal digital assistants, laptops, tablets or other mobile computing devices.

Electronic payments, however, still rely to a large extent on the exchange of personal information between the transacting parties, which in most cases involves the exchange of payment credentials and other personal information which allows the merchant access to, or direct authorisation to debit, a consumer's personal bank account. Not only is there an inherent risk in exchanging personal payment credentials as all merchants and, more importantly, the individuals they employ are not necessarily trustworthy, but the electronic transmission of payment credentials over data networks or “over-the-air” makes them vulnerable to interception by unscrupulous operators and so-called “man-in-the-middle” attacks.

The technology described in this application aims to address these and other problems associated with electronic payments at least to some extent.

In the remainder of this specification the term “electronic device” should be broadly construed to include any electronic device with at least some processing power and capabilities allowing it to communicate with remote devices over data networks including both wired and wireless kinds, as well as telecommunication networks. In particular, electronic devices may include personal computers, laptop computers, mobile phones including both feature and smart phones, tablets, smart watches and other personal digital assistants.

Similarly the term “transactional infrastructure” should be interpreted to include any electronic devices configured to conduct, or assist in the conducting of financial transactions and may include transaction servers, on-site or cloud based, transaction server networks as well as any electronic device referred to above.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with features of this disclosure there is provided a system for conducting electronic payment transactions between transaction initiators and transaction responders, the system comprising a server system in communication with transactional infrastructure of the transaction initiators and transaction responders, the server system including:
a transaction initiation component for receiving a transaction initiation request from the transactional infrastructure of a transaction initiator, the transaction initiation request including a transaction initiator identifier and parameters of a transaction to be concluded between the transaction initiator and one or more transaction responders, the transaction initiation request excluding any transaction responder specific information;
a token generation component for creating a first, responder independent, token representing the transaction;
a storage component for storing the first token in a database associated with the server system;
a communication component for communicating the first token to the transactional infrastructure of the transaction initiator;
a transaction response component for receiving a transaction response request from the transactional infrastructure of at least one transaction responder, the transaction response request including a responder identifier and a second token;
a token comparator component for comparing the first and second tokens; and
a transaction settlement component for settling the transaction between the transaction initiator and transaction responder if the first and second tokens are found by the token comparator to correspond.

Further features of this disclosure provide for the system to include an interface component customised for and deployed to the architectural infrastructure of each of the transaction initiators and transaction responders, the interface component providing user interfaces enabling, amongst others, transaction initiators to communicate transaction initiation requests to the transaction initiation component, and transaction responders to communicate transaction response requests to the transaction response component; for the server system and each interface component to include, or have associated therewith, a data encryption/decryption component for encrypting and decrypting communication between the server system and interface components; for encryption/decryption components of each interface component to have associated therewith a derivative encryption key derived from a master encryption key known only to the encryption/decryption component of the server system; and for encryption/decryption components of the server system and interface components to conduct asymmetric and/or Triple Data Encryption Algorithm (TDEA) encryption on data communicated between the server system and transactional infrastructure of the transaction initiators and transaction responders.

Still further features of this disclosure provide for the server system to further include a payment confirmation component for: responsive to the first and second tokens being found by the token comparator to correspond, compiling a payment confirmation message including at least some of the parameters of the transaction to be concluded; forwarding the payment confirmation message to the encryption/decryption component of the server system for encryption and onward transmission to the interface component of the transaction responder corresponding to the responder identifier included in the second token; receiving a payment confirmation or rejection message from the interface component of the transaction responder, the payment confirmation or rejection message including the transaction responder's confirmation or rejection of the transaction; and compiling and transmitting transaction approval messages to the interface components of the transaction initiator and responder transactional infrastructure if the payment confirmation or rejection message includes a confirmation of the transaction.

Transaction initiators and responders may include any one or more of retailers, including merchants, e-commerce, advertisers, promotional agencies and the like, consumers and communities of consumers represented by one or more authorised entities.

Transaction initiator and responder transactional infrastructure may include one or more of transaction servers, personal or portable computers, mobile electronic devices and the like, although in the case where the transaction responder is a consumer the transactional infrastructure may preferably be a mobile phone.

Transaction parameters may include one or more of a transaction amount, transaction reference, transaction alive time period, pre-authorisation limit, multiple responder indicator, multiple responder alive time period, overpayment allowed indicator, extra payment allowed indicator, extra payment alive time period, underpayment allowed indicator, underpayment percentage variance, underpayment alive time period and responder or consumer identifier.

Yet further features of this disclosure provide for the server system to include a transaction initiator and responder enrolment component for enrolling transaction initiators and responders for use of the system; for the enrolment component to facilitate compilation of custom software installable components for transaction initiators and responders during the enrolment process; and for each instance of custom software installable components to include at least an IP address, MAC address, derivative encryption key and transaction initiator or responder, as the case may be, identifier for the applicable transaction initiator or responder.

The technology extends to a system for conducting electronic payment transactions between transaction initiators and transaction responders, the system comprising a transaction server of a transaction initiator in communication with a server system of a transaction controller, the transaction server including:
a transaction initiation component for compiling a transaction initiation request including a transaction initiator identifier and parameters of a transaction to be concluded between the transaction initiator and one or more transaction responders, the transaction initiation request excluding any transaction responder specific information;
a communication component for communicating the transaction initiation request to the server system of the transaction controller;
a token receiving component for receiving a first, responder independent, token representing the transaction, from the server system of the transaction controller;
a token conveying component for conveying the first token, in printed, electronic or other format, to a consumer, for onward transmission by the consumer to the transaction controller over an independent communication channel; and
a transaction result component for receiving a transaction result from the server system of the transaction controller.

The technology further extends to a method for conducting electronic payment transactions between transaction initiators and transaction responders, the method being conducted at a server system and comprising the steps of:
receiving, at a transaction initiation component of the server system, a transaction initiation request from transactional infrastructure of a transaction initiator, the transaction initiation request including a transaction initiator identifier and parameters of a transaction to be concluded between the transaction initiator and one or more transaction responders, the transaction initiation request excluding transaction responder specific information;
creating, by way of a token generation component of the server system, a first, responder independent, token representing the transaction;
storing the first token in a database associated with the server system;
communicating, by way of a communication component of the server system, the first token to the transactional infrastructure of the transaction initiator;
receiving, by way of a transaction response component of the server system, a transaction response request from the transactional infrastructure of at least one transaction responder, the transaction response request including a responder identifier and a second token;
comparing, by way of a token comparator component of the server system, the first and second tokens; and
settling, by way of a transaction settlement component of the server system, the transaction between the transaction initiator and transaction responder if the first and second tokens are found by the token comparator to correspond.

Further features of this disclosure provide for the method to include the steps of customising and deploying an interface component to the architectural infrastructure of each of the transaction initiators and transaction responders, the interface component providing user interfaces enabling, amongst others, transaction initiators to communicate transaction initiation requests to the transaction initiation component, and transaction responders to communicate transaction response requests to the transaction response component; and encrypting and decrypting communication between the server system and interface components by way of an encryption/decryption component.

Still further features of this disclosure provide for the method to include the steps of, responsive to the first and second tokens being found by the token comparator to correspond, compiling a payment confirmation message by way of a payment confirmation component, the payment confirmation message including at least some of the parameters of the transaction to be concluded; forwarding the payment confirmation message to the encryption/decryption component of the server system for encryption and onward transmission to the interface component of the transaction responder corresponding to the responder identifier included in the second token; receiving a payment confirmation or rejection message from the interface component of the transaction responder, the payment confirmation or rejection message including the transaction responder's confirmation or rejection of the transaction; and compiling and transmitting a transaction approval messages to the interface components of the transaction initiator and responder transactional infrastructure if the payment confirmation or rejection messaged includes a confirmation of the transaction.

The technology still further extends to method for conducting electronic payment transactions between transaction initiators and transaction responders, the method being conducted at a transaction server of a transaction initiator and including the steps of:
compiling, by way of a transaction initiation component of the transaction server, a transaction initiation request including a transaction initiator identifier and parameters of a transaction to be concluded between the transaction initiator and one or more transaction responders, the transaction initiation request excluding any transaction responder specific information;
transmitting, by way of a communication component, the transaction initiation request to a server system of a transaction controller;
receiving a first, responder independent, token representing the transaction, from the server system of the transaction controller;
conveying, by way of a token conveying component of the transaction server, the first token, in printed, electronic or other format, to a consumer, for onward transmission by the consumer to the transaction controller over an independent communication channel; and
receiving, by way of a transaction result component, a transaction result from the server system of the transaction controller.

The invention also provides a computer program product for conducting electronic payment transactions between transaction initiators and transaction responders, the computer program product comprising a computer readable storage medium having computer-readable program code configured to carry out the steps of: receiving a transaction initiation request from transactional infrastructure of a transaction initiator, the transaction initiation request including a transaction initiator identifier and parameters of a transaction to be concluded between the transaction initiator and one or more transaction responders, the transaction initiation request excluding any transaction responder specific information; creating a first, responder independent, token representing the transaction; storing the first token in a database associated with the server system; communicating the first token to the transactional infrastructure of the transaction initiator; receiving a transaction response request from transactional infrastructure of at least one transaction responder, the transaction response request including a responder identifier and a second token; comparing the first and second tokens; and settling the transaction between the transaction initiator and transaction responder if the first and second tokens are found by the token comparator to correspond.

The invention also provides a computer program product for conducting electronic payment transactions between transaction initiators and transaction responders, the computer program product comprising a computer readable storage medium having computer-readable program code configured to carry out the steps of: compiling a transaction initiation request including a transaction initiator identifier and parameters of a transaction to be concluded between the transaction initiator and one or more transaction responders, the transaction initiation request excluding any transaction responder specific information; transmitting the transaction initiation request to a server system of a transaction controller; receiving a first, responder independent, token representing the transaction, from the server system of the transaction controller; conveying the first token, in printed, electronic or other format, to a consumer, for onward transmission by the consumer to the transaction controller over an independent communication channel; and receiving a transaction result from the server system of the transaction controller.

### BRIEF DESCRIPTION OF THE DRAWINGS

The invention will now be described, by way of example only, with reference to the accompanying representations in which:

FIG. 1 is a schematic illustration of an embodiment of a system for conducting electronic payment transactions according to the technology;

FIG. 2 is a schematic illustration of the communication flow between transaction initiators and responders, and a transaction controller according to the technology;

FIG. 3 is a swim-lane flow diagram illustrating a method for conducting electronic payment transactions according to the technology;

FIG. 4 is a block diagram illustrating components or modules of a server system (transaction controller) used in the system of FIG. 1;

FIG. 5 is a schematic illustration of an alternative embodiment of a system according to the technology, in which multiple responders may respond to the same transaction initiation request;

FIG. 6 is a swim-lane flow diagram illustrating enrolment of a transaction initiator or responder with a transaction controller according to the technology;

FIG. 7 is a swim-lane flow diagram illustrating a pre-authorisation transaction utilising the technology;

FIG. 8 is a schematic illustration of a further alternative embodiment of the system according to the technology, which incorporates multiple transaction controllers in geographically removed locations and configured to conduct cross-border and cross-currency transactions;

FIG. 9 illustrates an example of a server system in which various aspects of the disclosure may be implemented; and

FIG. 10 shows a block diagram of an electronic device that may be used in embodiments of the disclosure.

### DETAILED DESCRIPTION WITH REFERENCE TO THE DRAWINGS

In this specification the term “transaction initiator” is intended to have a wide meaning and encompass any entity that initiates a payment transaction with at least one transaction responder. In the majority of cases the transaction initiator will be an entity that will receive payment from the payment responder, and which initiates a payment transaction by requesting a transaction initiation from a transaction controller, while providing parameters relating to the transaction.

Similarly, the term “transaction responder” is intended to encompass any entity that responds to a transaction initiation, typically by confirming the transaction resulting in payment being effected. In the majority of cases the transaction responder will be the entity responsible for payment to a transaction initiator during the conclusion of a payment transaction, most commonly a consumer or community of consumers.

The most notable exception to the above being a payment pre-authorisation scenario in which the roles of transaction initiator and transaction responder are typically reversed. Such a scenario will be dealt with in detail further below.

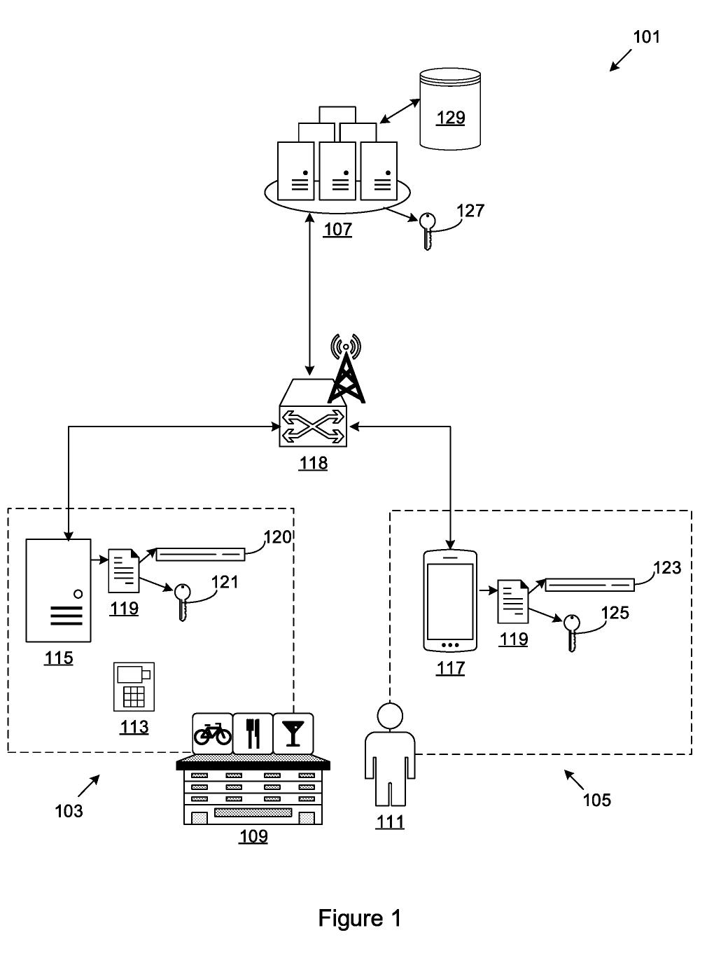

FIG. 1 illustrates an embodiment of a system (101) for conducting electronic payment transactions between a transaction initiator (103) and a transaction responder (105). The system (101) includes a server system, which will for ease of reference be referred to in what follows as a transaction controller (107). The transaction controller (107) is in data communication with transactional infrastructure of a transaction initiator, in this embodiment a brick and mortar retailer (109), and a transaction responder, in this embodiment a consumer (111) in the process of checking out at the retailer (109). In the case of the retailer (109), the transactional infrastructure includes a point-of-sale device (113) connected to a transaction server (115) of the retailer (109) in the usual fashion. In the case of the consumer (111), the transactional infrastructure comprises the consumer's mobile phone (117). Both the transaction server (115) and mobile phone (117) are capable of communicating with the transaction controller (107) through a data communication network which in the current embodiment is the Internet (118).

Both the transaction server (115) and mobile phone (117) have customised software operating thereon that provides application programming interfaces (APIs) (119) and, in the case of the consumer at least, a graphic user interface displayed on the mobile phone (117). The APIs (119) enable the retailer (109) and consumer (107) to interact with the transaction controller (107) over the Internet (118). The software is issued to the server (115) and mobile phone (117) during an enrolment process, the details of which will be explained in more detail further below. The software includes, in the case of the retailer (109), a unique retailer identifier (120) and a unique retailer derivative encryption key (121), and, in the case of the consumer (111), a unique consumer identifier (123), and a unique derivative encryption key (125). The identifiers (120, 123) and derivative encryption keys (121, 125) are issued to the retailer (109) and consumer (111) and are imbedded in the software issued to them during enrolment. It will be understood that the derivative encryption keys (121, 125) are derived from a master encryption key (127) that is only known to the transaction controller (107). It should also be appreciated that each derivative encryption key issued to a transaction initiator or responder may have its own associated master encryption key available only to the transaction controller (107) or, alternatively, all or any number of derivative encryption keys issued by the transaction controller (107) may be derived from a single master encryption key or a limited number of master encryption keys.

The transaction controller (107) also has a database (129) associated therewith.

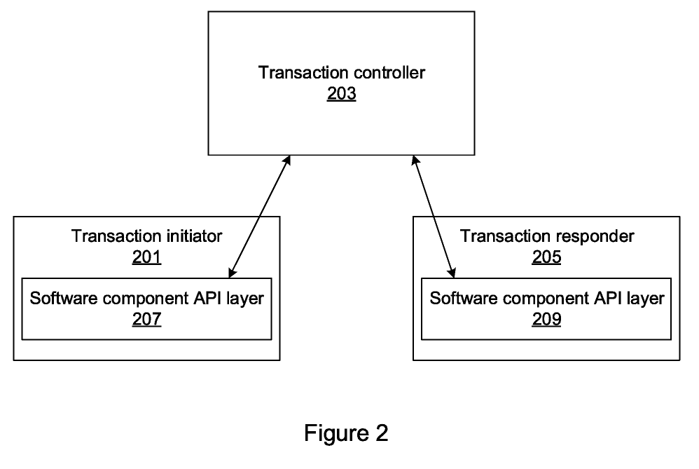

In the descriptions that follow, it should be noted that all communication between transactional infrastructure of a transaction initiator and the transaction controller, as well as between transactional infrastructure of a transaction responder and the transaction controller, can only be conducted through their corresponding APIs provided by the software installed on them during enrolment. This communication flow is illustrated in FIG. 2 as between a transaction initiator (201), transaction controller (203) and transaction responder (205). All communication conducted between an initiator (201) and the transaction controller (203) is conducted through an initiator side software component API layer (207). Likewise, all communication conducted between a responder (205) and the transaction controller (203) is conducted through a responder side software component API layer (209). The API layers of the transaction initiator and responder are also responsible for adding unique identifiers of the initiator (201) and responder (205), issued to them by the transaction controller (203) during enrolment, to all, or at least critical, transmissions from the initiator and responder to the transaction controller, as well as for encrypting and decrypting communication with the transaction controller. It should therefore be noted that where encryption or decryption of communications are referred to in what follows, such encryption or decryption will be handled by the API layers of the corresponding entities. Encryption and decryption of communications will be described in more detail further below. It will, however, be apparent to those skilled in the art that encryption of communication between the transaction controller and the various APIs of transaction initiators and responders may be the responsibility of the system controller, but that in scenarios where the responder is not the ultimate consumer, as is described in more detail below with reference to consumer communities, security of further communications between community infrastructure and consumer infrastructure may be the responsibility of the applicable communities.

In the remainder of this specification, a payment transaction initiated and concluded by means of the system (101) of the technology will be referred to as a “2D™” transaction. Similarly, a payment transaction conducted using the systems and methods described herein may be referred to as a “payment by 2D™”.

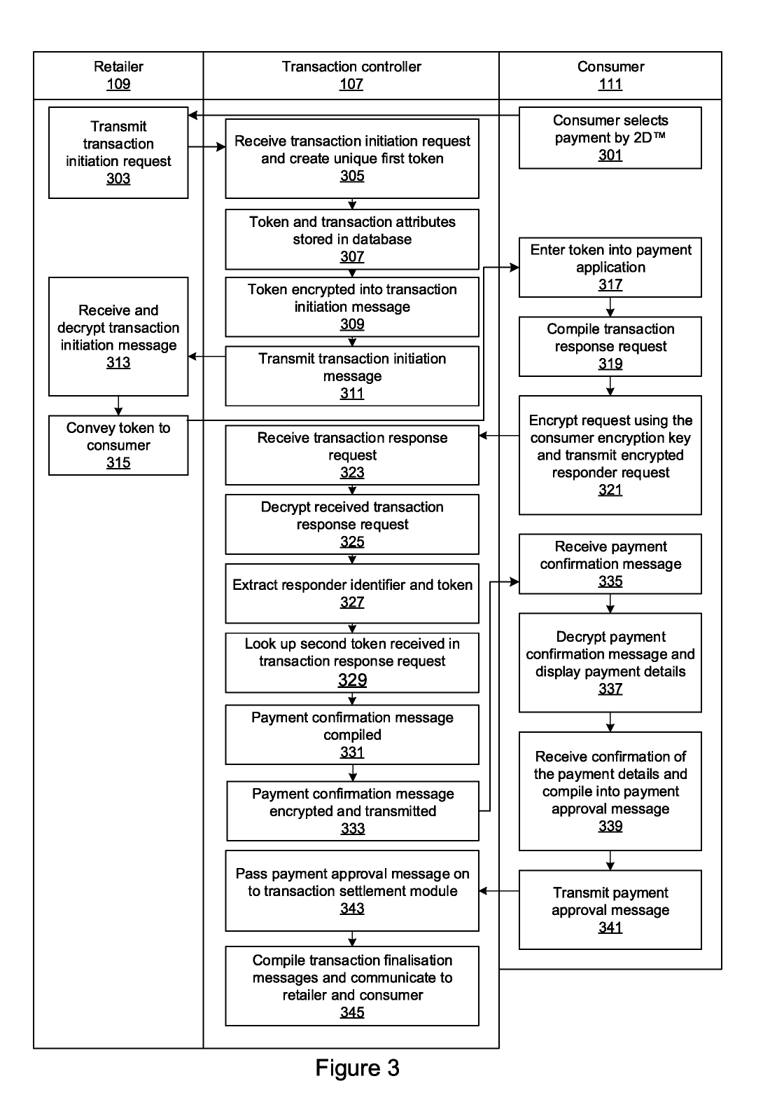

The basic operation of a system (101) according to the technology, and a method for conducting electronic 2D™ payment transactions between transaction initiators and transaction responders using a system (101), will now be explained with reference to the swim-lane flow diagram shown in FIG. 3. The entities involved in a 2D™ payment transaction in this example are as described above with reference to FIG. 1, and include the retailer (109), consumer (111) and transaction controller (107).

At a first step (301), the consumer (111) checks out at a payment point at the retailer (109), is asked to select a payment option and selects payment by 2D™. At step (303), the retailer (109) transmits a transaction initiation request to the transaction controller (107). The transaction initiation request is in effect a request for a first transaction token representing the transaction and includes at least a retailer identifier, which was issued to the retailer (109) during enrolment, and a limited set of parameters relating to the transaction which is in the process of being concluded. Such parameters may, for example, include a transaction amount, a transaction reference by which the transaction may be uniquely identified and an “alive-time-period” indicator indicating for what period of time the transaction will be valid.

The transaction controller (107) receives the transaction initiation request at step (305), and creates a unique first token, which represents the transaction and its parameters, or at least a subset thereof, but does not include any details of the consumer (111). The first token is therefore consumer (responder) independent. The token is then stored in a database associated with the transaction controller (107) at step (307), along with a number of transaction attributes which may include, for example, the initiator identifier, the amount of the transaction, the transaction reference, alive-time-period indicator, the currency in which the transaction is being conducted and a default transaction language, to name but a few. The token is then encrypted by the transaction controller into a transaction initiation message at step (309) and transmitted to the retailer (109) at step (311).

Upon receipt of the encrypted message, the retailer (109) decrypts the message and extracts the token at step (313). The token is then conveyed to the consumer (111) at step (315), in any one of a number of possible ways which may include displaying it on an electronic display, printing it on a slip, displaying it as a Quick Response (“QR”) code, printing it as a QR code, printing it as a two-dimensional barcode or in any other way.

In order to complete the payment, the consumer (111) then enters the token into a payment application on his or her mobile phone (117) at step (317). Of course the manner in which the token is entered into the mobile phone may depend entirely on the manner in which it was conveyed to the consumer (111). So, for example, if the token was displayed by the retailer (109) as a QR code, the consumer may simply be required to instruct the application that he or she wishes to enter a QR code token, in response to which the application may allow the consumer to scan the QR code with the camera provided by the mobile phone (117). Likewise, if the token was presented as a numerical or alphanumeric number, the consumer (111) may be required to manually enter the number into the GUI provided by the software. The API on the mobile phone (117) then compiles a transaction response request at step (319), which includes the token as well as at least the consumer's responder identifier issued to him or her during enrolment. The API then encrypts the request using the consumer (responder) derivative encryption key and transmits the encrypted response request to the transaction controller (107) at step (321).

Upon receipt of the transaction response request at step (323), the transaction controller (107) decrypts the received response request at step (325). Due to the fact that the transaction controller (107) is the only entity in possession of the master key used to derive the responder derivative encryption key, it is the only party capable of decrypting the transaction response request. After decryption, the transaction controller (107) extracts the responder identifier and token therefrom at step (327). The transaction controller may at this stage mark the extracted token as a second token as it is not yet established whether or not it corresponds to any token stored in the database (129). In practice, however, it will be appreciated that in the majority of cases the token included in the transaction response request will be the same as a token previously stored om the database by the transaction controller, but for the sake of clarity these tokens are differentiated until they have been confirmed by the transaction controller as being the same.

At step (329), the transaction controller (107) looks up the second token received in the transaction response request in the database (129) by comparing it to the tokens stored therein. If a matching first token is found in the database (129), the corresponding parameters of the transaction are retrieved from the database (129) and a payment confirmation message is compiled at step (331). The payment confirmation message may include payment details such as, amongst others, the name of the transaction initiator, the amount of the payment required and the transaction reference. The payment confirmation message is then encrypted and transmitted to the consumer's mobile device at step (333).

Upon receipt of the payment confirmation message at the consumer's mobile device at step (335), the responder side software application on the consumer's mobile phone decrypts the payment confirmation message and displays the payment details to the consumer at step (337), together with a request to the consumer to confirm the payment details. Upon receiving confirmation of the payment details from the consumer, such confirmation is compiled into a payment approval message at step (339), which is communicated to the transaction controller at step (341). The transaction controller in return passes the payment approval message on to a transaction settlement component of the transaction controller at step (343), which is responsible for settling the transaction between the retailer and consumer and effect payment between the parties. During settlement of the transaction the transaction token may be cleared from a pool of active tokens from the database and consumer and initiator accounts may be debited and credited accordingly and an audit trail entry of the transaction recorded for future reference.

The transaction controller then also compiles transaction finalisation messages, which are communicated to both the retailer (109) and consumer (111) at step (345), after which the transaction is considered as finalised.

It will be clear that, should a consumer fail to confirm or deny the payment details, that no payment approval message will be compiled at step (339). Instead, the transaction controller may compile a payment denial message which may be transmitted to the retailer and consumer. Naturally no settlement of the transaction may occur in such a scenario.

The above description of the operation of an embodiment of a system of the technology has been simplified for the purpose of explanation and actual implementations may be considerably more complex. However, even from the simplified embodiment it should be clear that the system of the technology provides significant advantages over existing technologies. Most notably, there are no physical cards or payment credentials presented between the initiator and responder during the transaction. The retailer accordingly does not need to enter, nor does it require, any information relating to the consumer or his her or payment credentials. The first token does therefore not include any consumer (responder) details or information and is accordingly responder independent. The consumer (responder) likewise does not need to identify the retailer (initiator), nor does he or she in fact need to identify the retailer at any stage during the conclusion of the transaction other than during the payment confirmation step referred to above. Even then, the retailer's identity is presented to the consumer and not the other way around. The consumer also does not have to enter any transaction parameters such as the payment amount or references as these parameters are inherent within the first token.

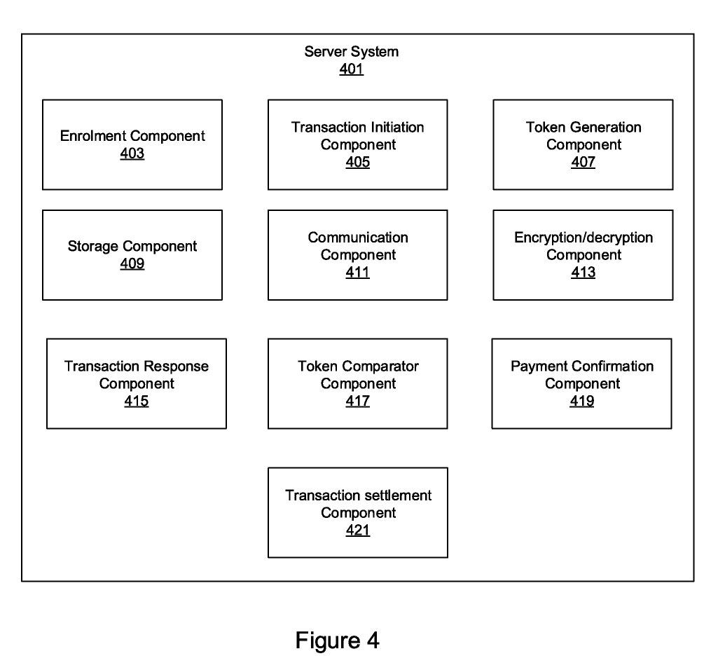

Referring to FIG. 4, in order to perform its various functions, the server system (401) of the transaction controller may include a number of functional components or modules for its operation, the first of which is an enrolment component (403). To enable transaction initiators and responders to use the system of the technology they have to be enrolled with the transaction controller. The enrolment process is elaborated on in more detail further below but for present purposes it should be noted that, during the enrolment process, all transaction initiators and responders are issued with customised software components imbedding, in the very least, the unique identifiers and derivative encryption keys referred to above. The enrolment component may also be responsible for, or merely facilitate, the compilation of the custom software installable components for transaction initiators and responders during the enrolment process.

In addition, the server system (401) includes a transaction initiation component (405) for receiving the transaction initiation request from the transaction initiator, a token generation component (407) for creating the first, responder independent token representing the transaction, a storage component (409) for storing the first token in the server system database, a communication component (411) for communicating with the initiator and responder transactional infrastructure, an encryption/decryption component (413) for encrypting and decrypting communication between the server system and the interface components of the transactional infrastructure of transaction initiators and responders, a transaction response component (415) for receiving transaction response requests from the transactional infrastructure of transaction responders, a token comparator component (417) configured to compare the first and second tokens, a payment confirmation component (419) for compiling payment confirmation messages and receiving payment approval messages from the interface component of the transaction responder and a transaction settlement component (421) for settling transactions between the transaction initiators and transaction responders.

The transaction initiator can of course be any one of a very large number of different entities including, but not limited to retailers, merchants, e-commerce websites, advertisers, promotional agencies as well as other consumers, for example in scenarios where consumers or end users wish to transact between themselves as individuals.

In an alternative example of a transaction conducted by means of the system of the technology the transaction initiator may be an e-commerce website. In such a scenario the transaction flow will proceed substantially the same as in the brick and mortar retailer scenario described above. Of course, instead of printing the first token representing the transaction and handing it over to the consumer, which in an e-commerce scenario is not an option, the e-commerce website may instead simply display the first token to the consumer on screen, after which the consumer may still enter or scan the token into his or her mobile phone or other transactional infrastructure.

It will be appreciated that numerous additional security measures may be added to the scenarios described without departing from the scope of the technology. For example, a consumer may be required to, in addition to the first token it received from the transaction initiator, enter a consumer specific personal identification number, biometric attribute or the like on his or her transactional infrastructure in order to send the transaction response request in the first place.

As before, no physical card or any other consumer sensitive information is entered on the e-commerce web site. The e-commerce retailer also does not enter nor require any information, personal, payment or otherwise, from the consumer. The first token again does not contain any consumer details or information. This may provide marked security advantages over existing technologies and may allow e-commerce operators to run unsecure (no SSL or 3-D Secure) websites, as no consumer information is captured during a transaction session.

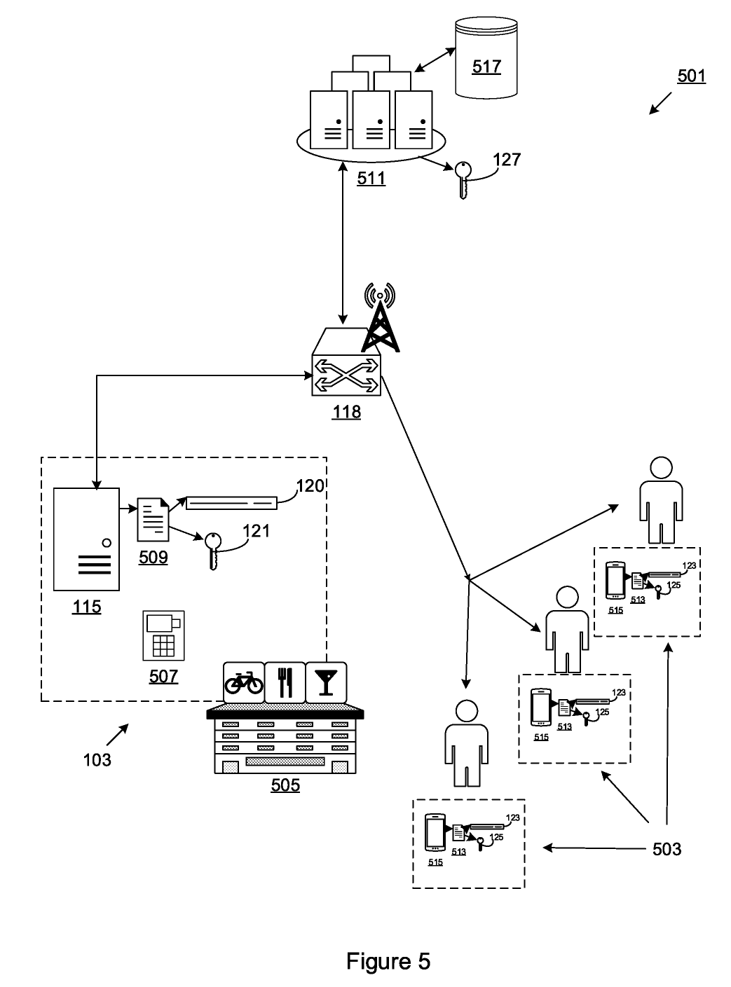

FIG. 5 illustrates an alternative embodiment of a system (501) according to the technology, in which multiple transaction responders, in the current embodiment diners (503) at a restaurant sharing a table can respond to the same transaction initiated by a single transaction initiator, in this case the restaurant (505) itself. In FIG. 5, as will be the case in further Figures referred to below, like reference numerals to those used above with reference to FIG. 1, refer to like components unless specifically referred to with new reference numerals.

Once the diners (503) have requested to pay the bill for their meal and indicated that they wish to make payment by 2D™, the waitron finalises the table on the restaurant's invoicing system (507), which in turn passes the payment parameters to the initiator side software component API (509), which creates a transaction initiation request including the transaction parameters and the initiator identifier, and encrypts the request using the initiator derivative encryption key issued to it during enrolment of the restaurant with the transaction controller (511). As before, the transaction controller then creates the unique first token, which represents the transaction and its parameters, and transmits it back to the initiator side software component API (509) which in turn passes it on to the restaurant invoicing system (507). The waitron then, for example, prints the first token on a bill which is presented to the diners at the table.

One or more of the diners may then have an option of settling the bill by entering the first token on the GUIs provided by the responder side software component APIs (513) on their mobile phones (515). To allow multiple diners (responders) to make payment towards the same bill, the first token could include an attribute which indicates that multiple responder request may be associated with that token. The transaction controller (511) may accordingly wait for multiple responder request to the combined value of the bill, or more, before allowing the transaction to be settled between the restaurant (505) and the various diners (503) responsible for payment of the bill. The responder side software component APIs (513) and associated GUI on the diners' mobile phones (515) may accordingly, either during the creation of the various transaction response request or during obtaining confirmation of the payment details from the respective responding diners, or at any other step during the process, request the various responding diners to indicate an amount which they wish to contribute towards payment of the bill. Such amounts could accordingly be compiled into the various transaction response requests or payment approval messages transmitted back to the transaction controller (511) by the various diner (responder) mobile phones.

Naturally, instead of looking up a single second token received in a transaction response request from a single responder in the database (517), the transaction may in this embodiment look up and compare multiple second tokens and match them up with a single first token stored in the database (517). As before, if a matching first token is found in the database (517), the corresponding parameters of the transaction are retrieved from the database (517) and payment confirmation messages compiled and transmitted to each of the diners (transaction responders), and the transaction is settled as before between the transaction controller (511) and the various diners (503).

In addition to the multiple responder attribute, the transaction parameters and/or first token may also specify a multiple responder alive time period (in seconds) attribute which provides a maximum time period within which all responder requests for payment towards the same first token have to be received and which, in combination, match or exceed the value of the initiated transaction. The transaction controller (511) will therefore park every transaction response request relating to the same multiple responder first token until the transaction amount was achieved or exceeded, failing which all received response requests may be cancelled and the relevant consumers notified accordingly.

The multiple responder in combination with multiple responder alive time period attributes may also be used in other payment transactions such as, for example, charitable contributions towards charities, competitions, bids, wedding or other celebratory gift registries and the like. An initiator could, for example, decide to initiate a token to a predefined value and only when the full value by any number of responders has been achieved will each responder be given a small prize/token of appreciation. In this example other attributes such as a multiple responder minimum amount may also be set so as to allow multiple people to make payment towards the same token, but not for less than a predefined amount. This may ensure that the transaction initiator at least collects more per responder than the actual value of the small prize/token of appreciation.

For competitions it could be indicated that the competition will only be “Active” if a predetermined value of contributions was reached within a specified time period.

In a bidding scenario multiple responders may be allowed to submit bids towards the purchase of a specific item against the same transaction token. Through other, custom attributes, some of which are described in more detail below, the token may also be set to honour the payment against the highest bid received by way of a transaction response request. Again, the multiple responder minimum amount attribute may be set to ensure that a bid cannot be awarded unless a specified reserve price has been achieved.

By way of further example, a wedding couple could initiate a payment token, with a multiple responder attribute but may include an attribute that there is no predefined amount to be reached, only an alive time period. In this case all guests who would like to make a financial contribution could then contribute to the same transaction token by submitting appropriate response requests, and the couple will not receive the funds until the alive time period has passed. An alternative to this would be a retailer issuing a transaction token for each item the wedding couple selected for a list of wedding gifts. The retailer may then set one or more of the tokens as multiple responder tokens, which will enable multiple guests to contribute towards the same gifts. Only when the total value of the gift in question has been reached will the transaction be finalised and settled between the retailer and the various responders.

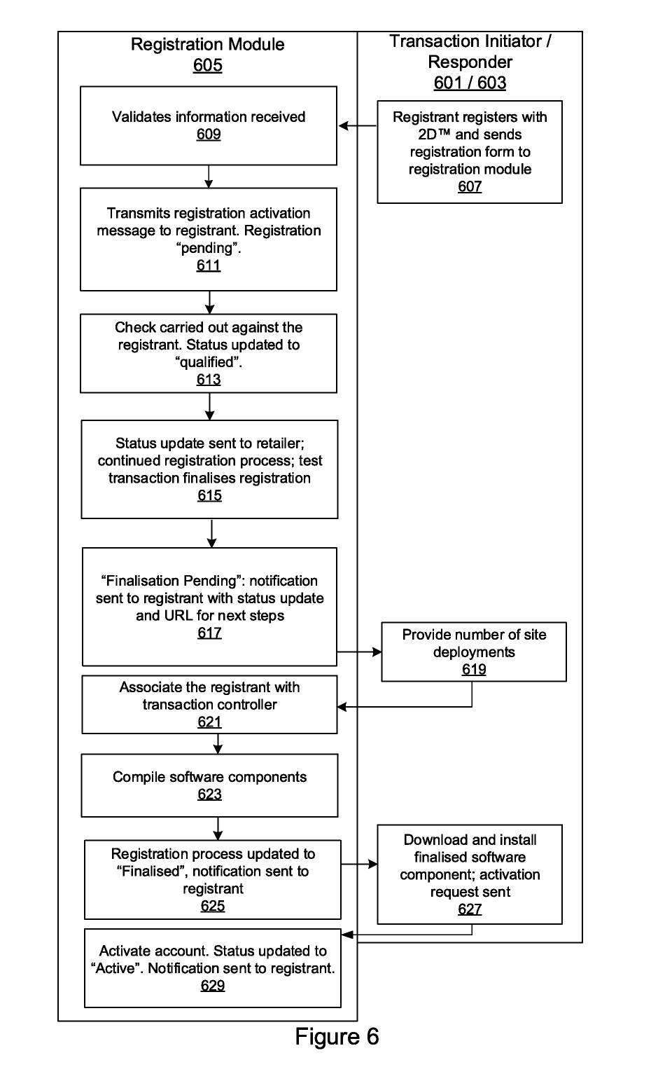

FIG. 6 shows a swim-lane flow diagram of the registration process of both transaction initiators (601) and transaction responders (603) with a transaction controller, more specifically a registration component (605) of a transaction controller, for use of the system according to the technology.

As explained above, the system according to the technology may be used for concluding payments between transaction initiators and transaction responders. The systems and methods of the technology, however, equally lend themselves towards conclusion of payments between entities that would typically, in the majority of their transactions, be regarded as transaction initiators, or transaction responders for that matter. Examples are where transactions are concluded and payments effected between different retailers, online communities, financial institutions, restaurants, merchants or e-commerce sites to name but a few. Likewise, end users (consumers) may wish to use the systems and methods of the technology to conduct payments between themselves in transactions like private sales of goods or services, money transfers and the like. It will therefore be clear that any transaction responder may also act as a transaction initiator and vice versa. For this reason the description of the registration process that follows is generic for both transaction initiators and transaction responders, although it should be noted that certain information gathered during the registration process may not be applicable to certain entities.

The registering party will for the sake of convenience simply be referred to as “the registrant” in what follows, although it will be noted that the registration process applies equally to both transaction initiators and transaction responders.

At a first step (607), the registrants decide to register with 2D™ and completes a registration form which could, for example, be a physical form which is handed or sent to the registration component or an entity responsible for registrations, an electronic form which could be submitted to the registration component or other entity responsible for registrations, or completed via email, fax, interactive voice response, through a call centre attendant in a call centre or an online registration form on an enrolment web page, dedicated enrolment device or the like.

The registration component (605) then validates information received at step (609), and sends a registration activation message including an activation URL to the registrant at step (611). At this point a registration activation is regarded as having been completed and the registration process enters a pending state for the applicable registrant. A suitable registration reference is provided to the registrant in any appropriate way.

The registration form may include the following minimum details, where applicable, of the registrant:
Company registered name (for non-individual registrants)
Company trading name (for non-individual registrants)
Company registration number (for non-individual registrants)
Company VAT number (for non-individual registrants)
Individual full names (for individual registrants)
Individual identification number (for individual registrants)
Physical address
Postal address
Contact number(s)
Company representative (for non-individual registrants)
Representative Contact Details (for non-individual registrants)
Email address
Web address
Banking institution name
Bank branch identifier
Bank account number (for settlement payments)
Daily guarantee limit request (for community pre-approved clearance)

At a next step (613), a thorough check is done against the registrant and the registrant's status is updated from “Pending” to “Qualified”. At step (615), an e-mail or other notification is sent to the registrant with its latest status update and a URL containing the next steps in the registration process, which may include an API specifications document for registrant integration, registrant test account or connection details and registrant test cases. The registration process then awaits a test transaction from the registrant and, once it is received, qualifies the test transaction at step (615). At this stage the registration process enters a “Finalisation Pending” state at step (617) and an e-mail or other communication is sent to the registrant with latest status update and a URL containing next steps in the registration process.

In the case where the registrant is a retailer or consumer community with multiple site deployments, the registrant is requested at step (619) to provide the number of site deployment it possesses (belonging to the same registrant and having the same bank account details), as well as a server IP address and server MAC address of the infrastructural architecture operating at, or for, each site deployment. At step (621), the registration component associates the registrant, and each site deployment with a specific transaction controller, it being noted that the systems and methods of the technology may have multiple transaction controllers operating in a single system.

At step (623), the registration component compiles, or commissions compilation of, final software installable components for the architectural infrastructure of the registrant or, in the case of a multiple site deployment registrant, each unique site deployment of such registrant. Embedded in each unique instance of the software installable components are a server IP address and MAC address of the architectural infrastructure as well as a triple length derivation key usable by the software component for conducting 3DES symmetric encryption. It will be noted that “3DES” as used in this specification is ascribed its ordinary meaning which in cryptography is Triple Data Encryption Algorithm (TDEA or Triple DEA) symmetric-key block cipher, which applies the Data Encryption Standard (DES) cipher algorithm three times to each data block.

At step (625) the status of the registration process is then updated from “Finalisation Pending” to “Finalised” and an email or other communication is sent to registrant with the status update and a URL providing access to the downloadable finalised software installable component for each registrant or site deployment in the case of multiple site deployments. At step (627) the registrant downloads and installs the software on its transactional infrastructure, which in turn transmits an activation request to the registration component or directly to the transaction controller, as the case may be. Upon receipt of the activation request the transaction controller activates the registrant's account at step (629), the account status is updated from “Finalised” to “Active” and an email or other communication is sent to the registrant with the latest status update and live production credentials.

It should be noted that the IP and MAC address referred to above are that of the transactional infrastructure of the registrant which will host each software installable component. Each unique software component provides the relevant registrant with an exposed API layer local to the transactional infrastructure, symmetric channel encryption using 3DES and the embedded triple length symmetric derivation key, network routing, the capabilities to establish connections with the transaction controller and a constant heartbeat for uptime link monitoring. Due to the nature of the security embedded in each software installable component, the symmetric channel encryption effectively establishes a private virtual network between the registrant and the transaction controller it is associated with, over a potentially otherwise unsecured network connection such as the Internet.

It is envisaged that future variations could allow for intermediary entities to become part of the retailer registration and support process. In such cases it may be possible to route 2D™ requests, both from transaction initiators and responders, via the intermediary platform to the transaction controller. Certain information can then be made available within the request to the intermediary as to facilitate reporting and reconciliation. It will be appreciated that end-to-end symmetric channel encryption remains in place even if 2D™ requests are routed via Intermediaries.

It will be appreciated that each registrant, be it in the normal course of events a predominantly initiating or responding user, will only be registered with a transaction controller once, but after registration can fulfil the role of both transaction initiator and responder. Also, and as already mentioned above, in the broader description of types of transaction initiators and responders, a retailer, which would in the majority of cases act as a transaction initiator, may initiate a 2D™ payment to which another retailer may respond. The same naturally applies to consumers, in that one consumer may initiate a 2D™ transaction to which another consumer may respond.

The systems and methods of this technology are accordingly not limited to any specific combinations of initiators and responders, but is rather an open platform by means of which parties may transact. Any party that is registered for use of the systems and methods may therefore initiate a 2D™ transaction resulting in the creation of a first transaction token, and anyone who is likewise registered may respond to a 2D™ token, resulting in the creation of a second 2D™ token. There are accordingly no restrictions (although it may foreseeably be set as optional variables) at the time of creation as to who may respond to a transaction token created in response to a transaction initiation request.

In practice, however, it is foreseeable that individual consumers may generally not be registered for 2D™ payments, but may instead be enabled to use the 2D™ payment platform by virtue of the fact that they are members of a community that is in turn so registered. It may therefore be by virtue of the fact that the community to which the consumer belongs is registered and approved for use of the 2D™ payment platform that the individual consumers will become 2D™ enabled. An example here would be a mobile money platform “XYZ” which has 1 million accounts associated with it. Mobile money XYZ would therefore register with the 2D™ payment platform as described above only once and through this onetime registration and approval, all 1 million account holders may become 2D enabled. Communities that may utilise the technology are, however, clearly not limited to mobile money or other payment platforms, but may include any community such as financial institutions (banks), closed user groups and virtual currency groups to name but a few.

Although it is foreseen that retailers would generally register individually for use of the technology, even retailers may be registered and enabled as members of a community. These retail communities could, for example include financial institutions (banks), other payment switches and closed user groups to name but a few.

In circumstances where consumers are able to utilise the technology by virtue of the fact that the communities to which they belong are formally registered for use of the technology, it is foreseen that registered communities may have pre-approved guaranteed payment amounts, for which the 2D™ payment platform may allow payments from community members to be immediately approved and/or honoured, without conducting further transaction approval checks which would otherwise be conducted, such as checking an account balance of the responding entity. The principle may work on the fact that once a consumer community is registered and approved for use of the 2D™ payment platform, that consumer community guarantees that the funds will be paid over to the 2D™ transaction operator/controller within the agreed settlement time period, as soon as it transmits a 2D™ payment approval message to the transaction controller.

It is foreseen that a consumer community (organization) may do a once off integration with the 2D™ platform to enable a 2D™ payment to be conducted on their own mobile application operating on their members' mobile phones. Mobile applications operating on member phones may simply be adapted to include options like “Request 2D™ Token”, “Pay by 2D™”, “Request pre-authorisation by 2D™” and the like. The risk for authentication that the funds are available in a consumer's account therefore rests with the community (organisation). The transaction controller may also have a guarantee of payment on all approved payments from such community (organization). Likewise a retailer may do a once off integration with the 2D™ platform to enable 2D™ payments at their store. It should be noted that the transaction controller of the technology may therefore perform and manage all transaction settlements as a net settlement between, for example, communities (organizations) and retailers.

The triple length derivation key referred to above may be calculated in a number of different ways. In one instance, the derivation key may be calculated by creating a 24 digit alphanumeric number, the first four digits of which comprises the sum of the numbers making up the IP address of the architectural infrastructure of the registrant on which the customised software instance will be operating, the following 12 digits comprise the first 6 paired values of the MAC address of the architectural infrastructure and the last 8 digits comprise the unique registrant identifier (be it initiator or responder) assigned to it during registration. By way of example, the 24 digit number may be calculated as follows:
IP: 196.35.123.155 (196+35+123+155)=509
MAC: 8C-A9-82-42-C9-67
Registrant ID: 10978665
24 digit number=0509.8CA98242C967.10978665

The 24 digit number may then be selectively encrypted with the derivation master key (“MK”) in possession of the transaction controller in 8 digit segments, each yielding a single hexadecimal digit. For example

Derivation: MK^{Encrypt}(05098CA9)_{A}^{Decrypt}(8242C967)_{B}^{Encrypt}(10978665)_{c}

The triple length derivation key may then be calculated as a concatenation of the three hexadecimal digits, A+B+C, resulting from the above calculations.

It will be apparent to those skilled in the art that the way in which the derivation keys are calculated may differ widely without departing from the scope of the invention. What is important rather, is that each custom software installable component compiled for each unique registrant includes a unique derivation key by means of which communications from the applicable registrant to the transaction controller responsible for registering the registrant may be unambiguously encrypted. Similarly, the derivation keys will enable registrants to unambiguously decrypt encrypted communications received from the transaction controller.

It will also be understood by those skilled in the art that transaction initiators and responders alike will only be able to transact using the technology if they are registered with a transaction controller and have an active status on their accounts, if they (or the communities to which they belong) have installed valid custom software installable components on their transactional infrastructure and they have an active network connection.

It is foreseen that transaction tokens representing the transactions may be created by the transaction controller in any number of different ways capable of uniquely identifying a transaction and its parameters. By way of example, however, the code may be an alphanumeric code which is made up in the following manner:
2 digits country/state code
   For example 5D=South Africa
      7F=Texas North America
1 digit transaction controller identifier or code
   8 could for example mean the controller with identifier 8 in the country determined by country code
   The controller can therefore be uniquely identified by the digits 5D8 as controller number 8 in South Africa
4 digit unique transaction reference
   It should be noted that different creators may use the same transaction reference sequences which may start with 4 digits but may grow to any number of digits depending on the algorithm and sequence of numbers in algorithm in use
   An exemplary algorithm for creating a transaction reference may be as follows:
      Start with any 4 uneven numbers (e.g. 1357) (The first 4 starting numbers may be randomly generated per transaction controller)
      Next number will be all digits of previous number except the first, and the previous first digit+1 as last digit
      4 digit example: 3572
         5724
         7246
      5 digit example: 13579
         35792
         57924
1 check digit verification check with modulus 10 variation for 2D™ specific algorithm

Alpha Character (regardless of lower or uppercase) is converted to ASCII value.

| | |
|---|---|
| 2D ™ Token | 5 D 8 1 3 5 7 |
| Becomes | 5 6 8 8 1 3 5 7 |
| Weighting | 1 2 1 2 1 2 1 2 |
| Result | 5 12 8 16 1 6 5 14 |
| Sum | 5 + 1 + 2 + 8 + 1 + 6 + 1 + 6 + 5 + 1 + 4 = 40 |
| CDV Mod 10 | 0 |
| 2D ™ Code | 5D 81 35 70 |

| | |
|---|---|
| 2D ™ Token | 5 D 8 1 3 5 7 9 |
| Becomes | 5 6 8 8 1 3 5 7 9 |
| Weighting | 2 1 2 1 2 1 2 1 2 |
| Result | 10 6 16 8 2 3 10 7 18 |
| Sum | 1 + 0 + 6 + 1 + 6 + 8 + 2 + 3 + 1 + 0 + 7 + 1 + 8 = 46 |
| CDV Mod 10 | 4 |
| 2D ™ Code | 5D 81 35 79 4 |

It should be noted that the 4 digit unique number per transaction controller could be appended with a 2 digit prefix, of which such prefix would be used for a specific 2D™ token type, in other words a 2D™ token attribute.

For example:
2D Code Type 00=Standard
2D Code Type 01=Pre Authorised
2D Code Type 02=Multiple Responders

Such an enhancement may become necessary once the recycling of available unique numbers (4-5 digit) becomes a problem. Some 2D™ token types may, for example, also require that a particular 2D™ token remains “Active” but expired for long periods of time and if the usage of some of these 2D™ token types becomes high, then it will constitute the use of 2D™ token types sooner.

| | |
|---|---|
| 2D Code | 5 D 8 0 2 1 3 5 7 |
| Becomes | 5 6 8 8 0 2 1 3 5 7 |
| Weighting | 1 2 1 2 1 2 1 2 1 2 |
| Result | 5 12 8 16 0 4 1 6 5 14 |
| Sum | 5 + 1 + 2 + 8 + 1 + 6 + 0 + 4 + 1 + 6 + 5 + 1 + 4 = 44 |
| CDV Mod 10 | 6 |
| 2D Code | 5D 80 21 35 76 |

The payment parameters communicated to the transaction controller with the transaction initiation request may include any number of different attributes or additional information, which may ultimately translate into token attributes incorporated in the first token representing the transaction. As a non-exhaustive list, these parameters may include one or more of the following:
Standard token <Y/N>
Pre-authorisation token <Y/N>
Multiple responders indicator <Y/N>
Multiple responders alive time period <in seconds>
Overpayment allowed <Y/N>
Extra payment allowed <Y/N>
Extra payment alive time period <in seconds>
Underpayment allowed <Y/N>
Underpayment % variance <value specified>
Underpayment alive time period <in seconds>
Custom defined attribute

Some of these tokens have already been discussed in more detail above and others are self-explanatory. For the sake of completeness, however, an overpayment allowed attribute makes provision for consumers to pay more than the amount associated with the token representing the transaction. This is ideal for a situation where a consumer would like to “bless” or “tip” the initiator.

Other attributes which could be used in conjunction with the attribute include, for example, an overpayment allowed % variance attribute. This would allow overpayments to a limit and once that limit is reached the last person contributing towards a multiple responder transaction may be asked to confirm that he or she would like to pay the applicable amount over and above the amount represented by the transaction token. As per the above example, if four people are paying the bill at a restaurant, this attribute would ensure that if 3 of the people have already offered to pay 80% of the bill, the 2nd person or 2nd and 3rd person may be asked to confirm that they want to pay that much more than their equal portion of the actual bill.

The extra payment attribute, together with the extra payment alive time period attribute could be perceived similar in characteristics as the above multiple responders and overpayment allowed attributes, yet these two attributes make provision for a transaction token that requires multiple responders, but for the exact same amount and every responder message received must immediately be honoured, thus no messages are “parked” until the amount represented by the token is equalled or exceeded. An example here would be a transaction token displayed on a billboard by a retailer. The retailer pre-requests and displays the token on the billboard in conjunction with a special whereby, if a responder acts upon (pays) this transaction token immediately or within a specified period of time, they will only pay the special, normally reduced price for the item. This implies that the retailer is requiring multiple “extra payments” for the same amount until the extra payment alive time period has expired. Another example may be where a transaction token is displayed as a QR or other 2- or 3-dimensional code, as part of an advertisement in a magazine, selling a product at a specific price. An additional attribute that could be introduced in this regard would be an extra payment allowed count attribute which may be used to limit a special to the first x number of responders. The advertisement could then indicate that the first 30 people for example would get the product at the special price.

The same attributes can also be used for account repayments (debt payments) for example. A credit company could, for example, initiate a transaction code which could be used for a predefined number of recurring payments towards an outstanding credit amount.

Alternative attributes may allow for underpayments to be made. This makes provision for a responder to respond to a transaction token (stated at a specific amount) and, should they respond within a predefined time period, they will be allowed to pay x % less than the specified amount. Again, these attributes may work in combination with previously described attributes. An example here would be transaction tokens generated for promotional items from retailers. Again a transaction token may be displayed for a product at full value (amount) with the enticement that if the token is responded to (paid) before a specified date, the responder qualifies for the % discount, yet should further responders respond after the specified date they may still be able to purchase the product but not at the promotional price.

The transaction parameters or attributes referred to above do not constitute an exhaustive list but are mentioned for illustrative purposes alone. It is foreseen that numerous additional and alternative attributes may be utilised in a similar manner. It is also foreseen that the technology may provide user customisable attributes to suit individual requirements.

It is furthermore foreseen that the above and other parameters and attributes may be provided for and managed by a rules engine associated with the transaction controller, with rules that may be dynamically added to and adapted as required.

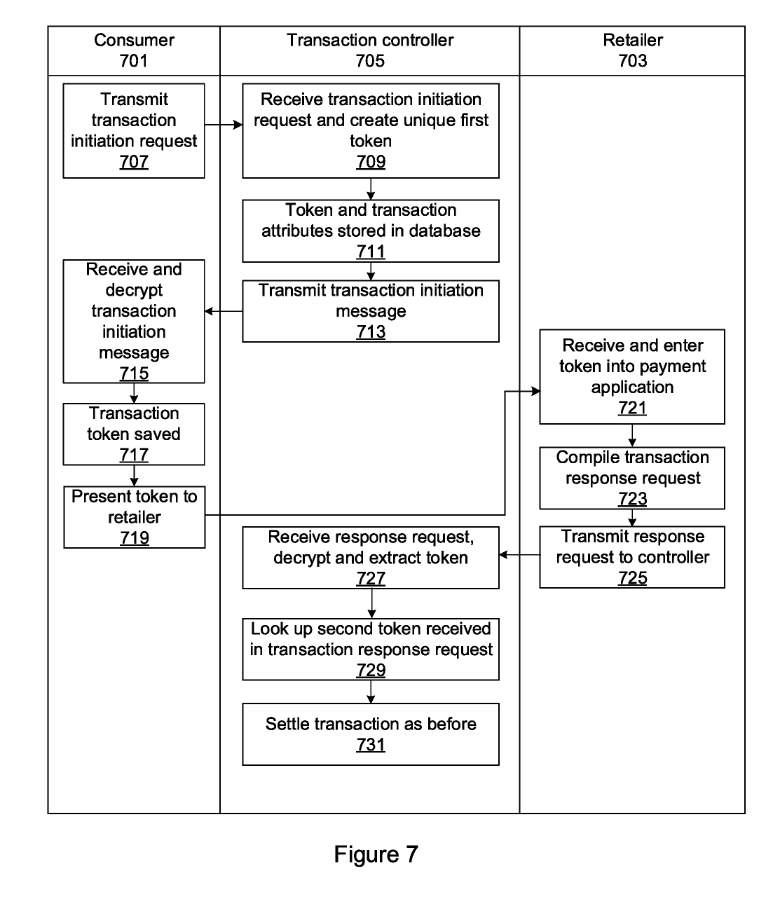

Referring now to the swim-lane flow diagram of FIG. 7, the system of the technology may be used to conduct pre-authorised payments of transaction which are still to be concluded. In such a scenario the normal roles of the transaction initiator, in this example the consumer (701) and transaction responder, in this example a retailer (703) as explained above, are essentially reversed. While the technical details of how a transaction is initiated and a transaction token generated remain substantially the same as described above, it is the transaction responder or, to avoid confusion, the consumer (701) that initiates a transaction by compiling and transmitting the transaction initiation request to the transaction controller (705) from his or her 2D™ enabled electronic device, in this embodiment a mobile phone.

To initiate a transaction the consumer (701) decides to pre-authorise spending on his or her account up to specified amount, and transmits a transaction initiation request with details of the pre-authorisation, including the pre-authorisation amount, to the transaction controller (705) from his or her mobile phone at step (707). Upon receipt of the request at step (709), the transaction controller (705) generates the first token representing the pre-authorisation transaction, stores the token along with the transaction parameters and attributes in its database at step (711) and transmits it back to the consumer's mobile phone or other device, as part of the transaction initiation message at step (713). Upon receipt of the transaction initiation message from the transaction controller (705), the message is decrypted at step (715) and the transaction token saved on the consumer's mobile phone, written down, printed or captured by any alternative suitable means by the consumer or his or her device at step (717).

The consumer then proceeds to shop at the retailer (703) of his or her choice and upon checkout opts to pay by means of 2D™ pre-authorised payment. The consumer (701) then presents the payment token to the payment point operator at step (719) in any suitable manner which may include, without limitation, presenting it on the mobile phone screen for manual capture by the payment point operator onto the point-of-sale device, transmitting the token to the point-of-sale device by means of wireless communication such as Bluetooth, Wi-Fi, NFC or the like, or by the consumer entering the token on a manual entry device him- or herself. Upon receipt of the token at step (721), the retailer (703) transactional infrastructure, utilising the unique software component installed thereon, compiles a transaction response request including the first token, parameters of the transaction such as the amount, and unique retailer identifier at step (723), and transmits it to the transaction controller (705) at step (725).

The transaction controller (705) in turn receives the transaction response request, decrypts it and extracts the second transaction token contained therein at step (727). As before, the controller (705) then looks up the second token in the database at step (729) and, in particular, looks if it matches a pre-authorisation token previously issued to the consumer, after which the transaction is settled or declined as before at step (731). The transaction controller may also conduct a number of additional checks on the first and second tokens including, for example, whether the first token includes a pre-authorisation limit, that the alive time period contained in the first pre-authorisation request has not expired, that the transaction response request includes an amount of the transaction and that the amount of the transaction does not exceed the pre-authorisation amount, to name but a few. If a matching entry is found in the database and all the checks are positive, the transaction is approved, if not, the transaction is declined and both the consumer (701) and retailer (703) receive corresponding transaction approval or decline messages from the transaction controller (705).

As before, it should be noted that the consumer (701) at no point identifies the retailer (703), nor does he or she have to identify the retailer (703). As no physical cards or other payment credentials are exchanged between the parties there is no risk of the consumer's payment credentials being jeopardised. The retailer (703) also does not enter any personal information of the consumer (701), except for the transaction token received from the consumer. It should be noted that a pre-authorisation token as described above could easily be transferred between consumers, thus enabling consumers to provide other consumers the ability to transact against their accounts, but only up to a predetermined amount. A downside to the pre-authorisation scenario described is of course that the bearer for the time being of the pre-authorisation token carries the onus of ensuring that it is kept safe. If the token is leaked to unintended parties, any such party can transact against it without the original bearer's permission. It is foreseeable that the pre-authorised transaction token could have expiry and other payment attributes assigned to it based on the criteria required by the consumer. It is also foreseen that multiple pre-authorised transaction tokens may be created for as long as the consumer has sufficient funds available in their account.

Another attribute or rule that is envisaged is the provision of a “chained” or “embedded” token ability. By way of example, if a transaction initiator provides a variety of products or services that may be purchased by a consumer, each such product or service may have a pre-generated transaction token already assigned to it. It should be appreciated that such tokens may already have “multiple responder” attributes assigned to them allowing any number of responders to purchase the items, as described in more detail above. This would typically be the situation in an online retailer environment. If a consumer wishes to purchase a single item the transaction could be concluded using only the pre-generated transaction token. If, however, the consumer wishes to purchase a number of such items in a single transaction, the items may be added to an online basket while the consumer is shopping. When the consumer then decides to “check out”, the online retailer may send a new transaction initiation request to the transaction controller with details of all the pre-generated tokens of the selected items. The transaction controller may then generate a new, single, “chained” token having the individual pre-generated tokens embedded therein, which the consumer can then use to purchase the selected items in a single transaction. Upon receipt of a transaction response request included such a chained token, the transaction controller may first resolve the chained token by extracting all the embedded tokens and then settle each individual item token as between the initiator of such token and the responder. The advantages of such a chained attribute should be self-evident, as it would allow a consumer to purchase a number of different items, possibly originating from different transaction initiators, in a single transaction.

In circumstances where the consumer requesting a pre-authorised transaction token is enabled to use the 2D™ payment system and platform by virtue of the fact that a community to which the consumer belongs is registered for use of the technology, the onus of authorisation may rests with the request initiator community platform. In these circumstances the transaction controller may receive an irrevocable request instruction which will be honoured irrevocable to the maximum of the specified amount. A pre-authorised transaction token is initiated through a community registrant may therefore an irrevocable guarantee of payment up to and inclusive of the amount specified. The alive time period attribute for a pre-authorised token may preferably be set to the minimum allowable time period so as to limit the risk of the token falling into unauthorised hands. Further attributes to be set for pre-authorised tokens may, for example, include an intended responder attribute, will may limit the risk of exposure on the pre-authorised token.

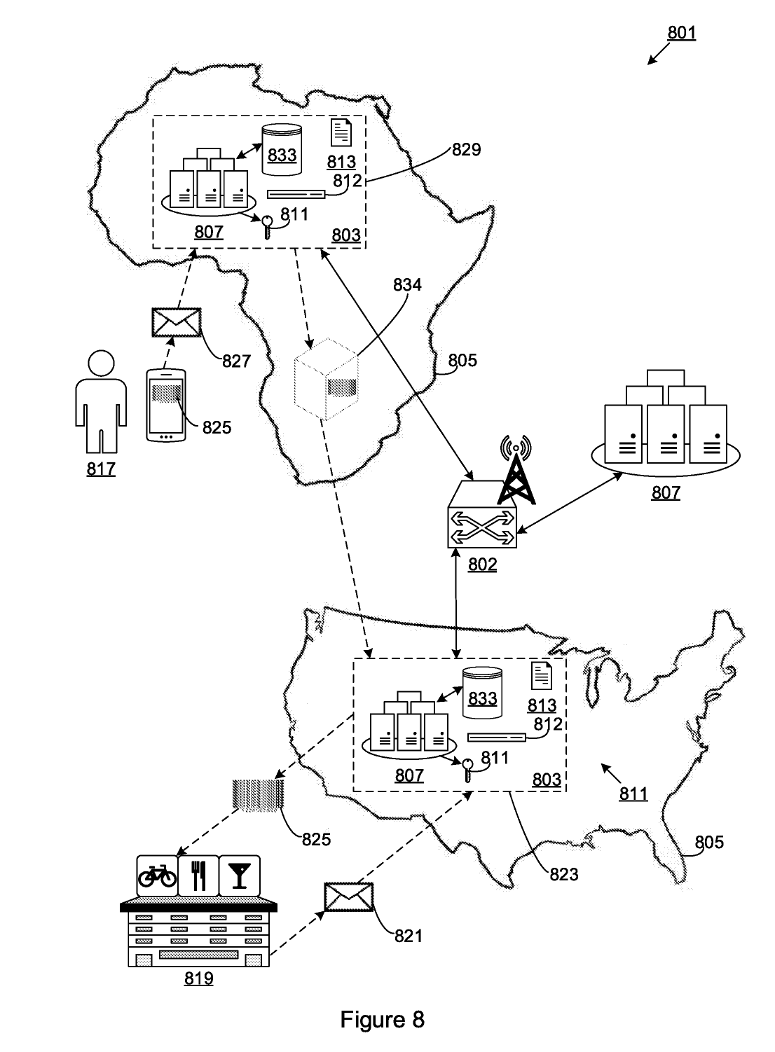

Referring now to FIG. 8, a system (801) according to the technology may be distributed across the world and include one or more instances of transaction controllers (803) per country (805). The transaction controller instances (803) may in turn be in remote communication with a master control server (807), with which they are configured to communicate over a communication network such as the Internet (802). The system (801) of this embodiment carries with it a number of additional implications, as well as possibilities such as cross-border and cross-currency transactions.

As mentioned before, registrants including both transaction initiators and responders may enrol for use of the technology with the transaction controller (803) that is geographically or logistically closest or most convenient, most commonly this will imply that registrants from a particular country will enrol with the transaction controller that is based in or dedicated to that country. It should however be noted that more than one transaction controller (803) may be employed per country. Importantly, however, each registrant may enrol with a single transaction controller and its unique software component compiled and employed on its transactional infrastructure may be preconfigured to communicate only with the transaction controller with which it has been enrolled.

While still under control of the master control server (807), each transaction controller (803) will be configured with its own unique transaction controller identifier or code (812) issued to it by the master control server (807), a unique triple length master key (811), a unique IP address, a unique MAC address and a unique triple length derivation key as discussed in more detail above. In addition, each transaction controller (803) may have a local 2D™ routing table (813) which is maintained and updated by the master control server (807) as and when required. Each routing table (813) may include, amongst others, an entry for each transaction controller (803) in the system (801) with the below information or at least a subset thereof:
a 2 digit country/state code
a 1 digit transaction controller identifier
an IP Address
a port Value
a MAC Address
a currency indicator
a default language indicator
and settlement details including, amongst others,
   a settlement institution
   a settlement account
   a settlement occurrence or frequency (daily, weekly)
   a settlement cut-off time (GMT)
   and a settlement currency

It will be appreciated that the system (801) according to this embodiment enables cross-border and cross-currency transactions to be conducted with minimal additional overheads. A transaction responder, in this example an online shopper (817) may, for example, be shopping on an online e-commerce website of a transaction initiator entity in a different country, in this example an online retailer (819). When the shopper (817) has finished shopping, decides to check out and chooses to pay by 2D™ payment, the retailer (819) sends a transaction initiation request (821) to the transaction controller (823) with which it is enrolled. The transaction controller (823) creates the first token (825) as before, including its own country code and transaction controller identifier in the token (825).

The shopper (817) in turn enters the first token (825) on his or her electronic device, which compiles and transmits the transaction response request (827) to the transaction controller (829) with which it was enrolled which, in the current example, is an entirely different transaction controller, in another country to the one that created the first token (825).

Upon receipt of the transaction response request (827), the transaction controller (829) of the shopper (817) decrypts the request as previously explained, extracts the token (825) and does a lookup of the token (825) in its local database (833), using the first 3 digits of the token (825) in its local routing table (813) to determine identity and communication details of the transaction controller (823) responsible for creating the token (825). If it is determined that the creator of the token (825) was another controller, the responding controller (829) compiles a relay request (834), which includes the responding controller's (829) controller identifier, and passes the relay request (834), including the token (825) on to the correct, initiating controller (823) responsible for creating it. It should be noted that as with communications between local transaction controllers and registrants, communications between different transaction controllers are also encrypted.

Upon receipt of the relay request (833), the initiating controller (823) decrypts the request (834), extracts the transaction token (825) and settles the transaction in the same way as previously described. It being noted, however, that settlement of payments may in the current example involve cross currency payments between the various parties involved.

The above descriptions of embodiments of the technology are by way of example only and it will be evident to those skilled in the technology that numerous changes and modifications may be made to the embodiments described without departing from the scope of the invention. The technology provides a single payment process involving two “dimensions” to the payment. One being the initiator of the payment and the second being the responder to the payment. Importantly, the two are not linked and therefore the two dimensions can take place at different times, geographical locations and are not linked or associated until brought together by the transaction controller. The transaction token created by the initiator therefore exists as an independent “object 1” that contains certain information and is awaiting a second, “object 2” (or multiple second objects) to be associated with it. Only once these two objects (dimensions) have been associated can the transaction be finalised and payment effected between the parties.

From the above description it should be noted that transaction tokens generated have numerous unique characteristics which add to their usefulness. These may include, without limitation, the fact that:
they carry no time (can exists for seconds or months, years)
they carry no geographical requirements (no need to be present)
they can be any length (from 8 digits to multiple digits)
they can be for any currency (object one for one currency and object two another currency, therefore a global code)
neither object is associated with the other in any way until both objects are brought together by the transaction controller
object one can either be finalised by one other second object, or multiple second objects
the transaction token can be presented in a variety of formats, for example, just numerical numbers, alpha-numerical characters in combination with numerical numbers, a bar code image, a QR code, or any future technology available for representation. It can therefore be used on any device, from old device technologies to latest smart devices. It is not limited to a mobile phone but can be any device, including satellite phones and the like

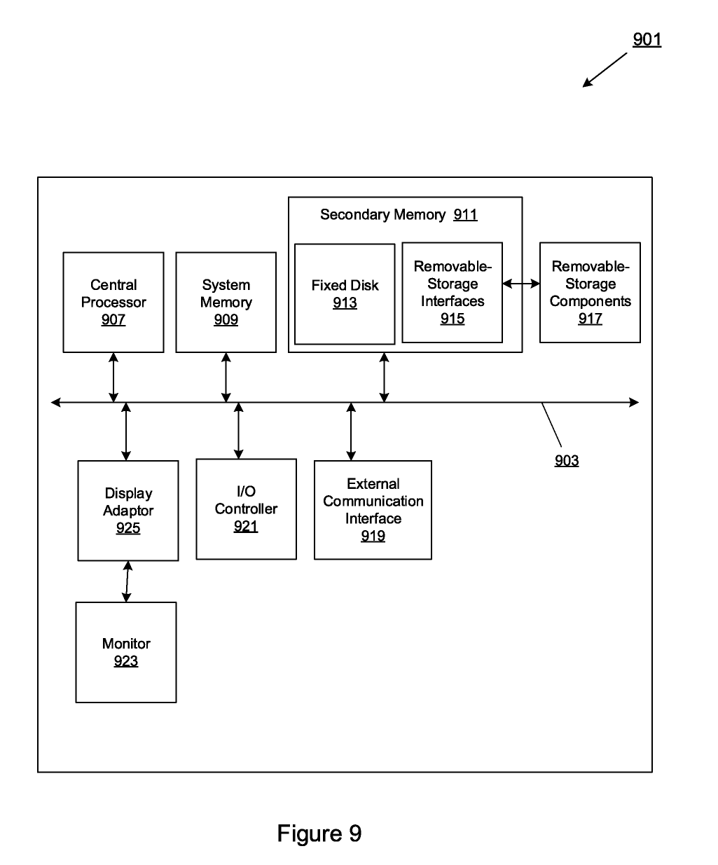

FIG. 9 illustrates an example of a server system (901) in which various aspects of the disclosure may be implemented. The server system (901) may be suitable for storing and executing computer program code. The various participants and elements in the previously described system diagrams may use any suitable number of subsystems or components of the server system (901) to facilitate the functions described herein.

The server system (901) may include subsystems or components interconnected via a communication infrastructure (903) (for example, a communications bus, a cross-over bar device, or a network). The server system (901) may include at least one central processor (907) and at least one memory component in the form of computer-readable media.

The memory components may include system memory (909), which may include read only memory (ROM) and random access memory (RAM). A basic input/output system (BIOS) may be stored in ROM. System software may be stored in the system memory (909) including operating system software.

The memory components may also include secondary memory (911). The secondary memory (911) may include a fixed disk (913), such as a hard disk drive, and, optionally, one or more removable-storage interfaces (915) for removable-storage components (917).

The removable-storage interfaces (915) may be in the form of removable-storage drives (for example, magnetic tape drives, optical disk drives etc.) for corresponding removable storage-components (for example, a magnetic tape, an optical disk etc.), which may be written to and read by the removable-storage drive.

The removable-storage interfaces (915) may also be in the form of ports or sockets for interfacing with other forms of removable-storage components (917) such as a flash memory drive, external hard drive, or removable memory chip, etc.

The server system (901) may include an external communications interface (919) for operation of the server system (901) in a networked environment enabling transfer of data between multiple server systems (901). Data transferred via the external communications interface (919) may be in the form of signals, which may be electronic, electromagnetic, optical, radio, or other types of signal.

The external communications interface (919) may enable communication of data between the server system (901) and other server systems including external storage facilities. Web services may be accessible by the server system (901) via the communications interface (919).

The external communications interface (919) may also enable other forms of communication to and from the server system (901) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (907).

A computer program product may be provided by a non-transient computer-readable medium, or may be provided via a signal or other transient means via the communications interface (919).

Interconnection via the communication infrastructure (903) allows a central processor (907) to communicate with each subsystem or component and to control the execution of instructions from the memory components, as well as the exchange of information between subsystems or components.

Peripherals (such as printers, scanners or the like) and input/output (I/O) devices (such as a mouse, touchpad, keyboard, microphone, or the like) may couple to the server system (901) either directly or via an I/O controller (921). These components may be connected to the server system (901) by any number of means known in the art, such as a serial port. One or more monitors (923) may be coupled via a display or video adapter (925) to the server system (901).

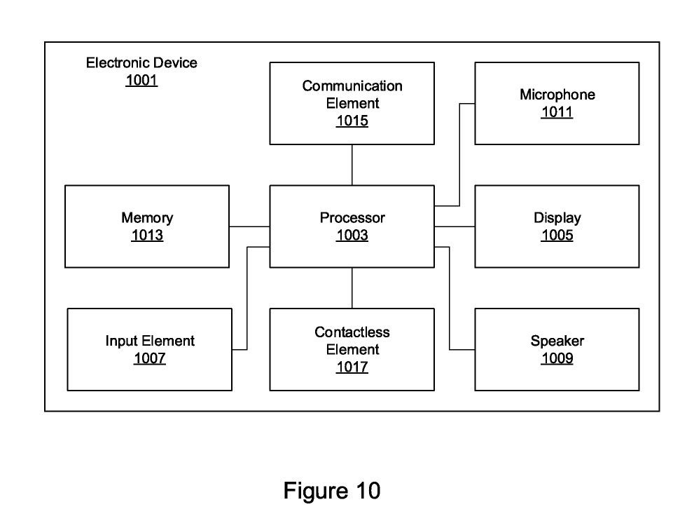

FIG. 10 shows a block diagram of an electronic device (1001) that may be used in embodiments of the disclosure. The electronic device (1001) may be a mobile cell phone, a feature phone, a smart phone, a satellite phone, or a computing device having a phone capability.

The electronic device (1001) may include a processor (1003) (e.g., a microprocessor) for processing the functions of the electronic device (1001) and a display (1005) to allow a user to see the phone numbers and other information and messages. The electronic device (1001) may further include an input element (1007) to allow a user to input information into the device (e.g., input buttons, touch screen, etc.), a speaker (1009) to allow the user to hear voice communication, music, etc., and a microphone (1011) to allow the user to transmit his or her voice through the electronic device (1001).

The processor (1003) of the electronic device (1001) may connect to a memory (1013). The memory (1013) may be in the form of a computer-readable medium that stores data and, optionally, computer-executable instructions.

The electronic device (1001) may also include a communication element (1015) for connection to communication channels (e.g., a cellular telephone network, data transmission network, Wi-Fi network, satellite-phone network, Internet network, Satellite Internet Network, etc.). The communication element (1015) may include an associated wireless transfer element, such as an antenna.

The communication element (1015) may include a subscriber identity module (SIM) in the form of an integrated circuit that stores an international mobile subscriber identity and the related key used to identify and authenticate a subscriber using the electronic device (1001). One or more subscriber identity modules may be removable from the electronic device (1001) or embedded in the electronic device (1001).

The electronic device (1001) may further include a contactless element (1017), which is typically implemented in the form of a semiconductor chip (or other data storage element) with an associated wireless transfer element, such as an antenna. The contactless element (1017) may be associated with (e.g., embedded within) the electronic device (1001) and data or control instructions transmitted via a cellular network may be applied to the contactless element (1001) by means of a contactless element interface (not shown). The contactless element interface may function to permit the exchange of data and/or control instructions between mobile device circuitry (and hence the cellular network) and the contactless element (1017).

The contactless element (1017) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the electronic device (1001) and an interrogation device. Thus, the electronic device (1001) may be capable of communicating and transferring data and/or control instructions via both a cellular network and near field communications capability.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description are in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM) or a read-only memory (ROM). Any such computer-readable medium may also reside on or within a single computational apparatus, and may be present on or within different computational apparatuses within a system or network. Any of the steps, operations, or processes described herein may be performed or implemented with one or more hardware or software components, alone or in combination with other devices. In one embodiment, a software component is implemented within a computer program product comprising a non-transient computer-readable medium containing computer program code, which can be executed by a computer processor for performing any or all of the steps, operations, or processes described herein.

Any of the steps, operations, or processes described herein may be performed or implemented with one or more hardware or software components, alone or in combination with other devices. In one embodiment, a software component is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A system for conducting electronic payment transactions between transaction initiators and transaction responders, the system comprising a server system in communication with transactional infrastructure of the transaction initiators and transaction responders, the server system comprising:
a transaction initiation component for receiving a transaction initiation request from the transactional infrastructure of a transaction initiator, the transaction initiation request including a transaction initiator identifier and parameters of a transaction to be concluded between the transaction initiator and one or more transaction responders, the transaction initiation request excluding any transaction responder specific information;
a token generation component for creating a first, responder independent, token representing the transaction;
a storage component for storing the first token in a database associated with the server system;
a communication component for communicating the first token to the transactional infrastructure of the transaction initiator;
a transaction response component for receiving a transaction response request from the transactional infrastructure of at least one transaction responder, the transaction response request including a responder identifier and a second token;
a token comparator component for comparing the first and second tokens; and
a transaction settlement component for settling the transaction between the transaction initiator and transaction responder if the first and second tokens are found by the token comparator to correspond.

2. The system as claimed in claim 1, further comprising an interface component customised for and deployed to the architectural infrastructure of each of the transaction initiators and transaction responders, the interface component providing user interfaces enabling transaction initiators to communicate transaction initiation requests to the transaction initiation component, and transaction responders to communicate transaction response requests to the transaction response component.

3. The system as claimed in claim 2, wherein each interface component and the server system have data encryption/decryption components associated therewith for encrypting and decrypting communication between the server system and interface components.

4. The system as claimed in claim 3, wherein the encryption/decryption components of each interface component has a derivative encryption key derived from a master encryption key known only to the encryption/decryption component of the server system, associated therewith.

5. The system as claimed in claim 3, wherein the encryption/decryption components of the server system and interface components conduct asymmetric and/or Triple Data Encryption Algorithm (TDEA) encryption on data communicated between the server system and transactional infrastructure of the transaction initiators and transaction responders.

6. A system as claimed in claim 3, wherein the server system includes a payment confirmation component configured for:
responsive to the first and second tokens being found by the token comparator to correspond, compiling a payment confirmation message including at least some of the parameters of the transaction to be concluded;
forwarding the payment confirmation message to the encryption/decryption component of the server system for encryption and onward transmission to the interface component of the transaction responder corresponding to the responder identifier included in the second token;
receiving a payment confirmation or rejection message from the interface component of the transaction responder, the payment confirmation or rejection message including the transaction responder's confirmation or rejection of the transaction; and
compiling and transmitting transaction approval messages to the interface components of the transaction initiator and responder transactional infrastructure if the payment confirmation or rejection message includes a confirmation of the transaction.

7. A system as claimed in claim 1, wherein the server system includes a transaction initiator and responder enrolment component for enrolling transaction initiators and responders for use of the system.

8. A system as claimed in claim 7, wherein the enrolment component facilitates compilation of custom software installable components for transaction initiators and responders during the enrolment process.

9. A system as claimed in claim 8, wherein each instance of custom software installable components includes at least an IP address, MAC address, derivative encryption key and transaction initiator or responder identifier for the applicable transaction initiator or responder.

10. A system for conducting electronic payment transactions between transaction initiators and transaction responders, the system comprising a transaction server of a transaction initiator in communication with a server system of a transaction controller, the transaction server comprising:
a transaction initiation component for compiling a transaction initiation request including a transaction initiator identifier and parameters of a transaction to be concluded between the transaction initiator and one or more transaction responders, the transaction initiation request excluding any transaction responder specific information;
a communication component for communicating the transaction initiation request to the server system of the transaction controller;
a token receiving component for receiving a first, responder independent, token representing the transaction, from the server system of the transaction controller;
a token conveying component for conveying the first token to a consumer for onward transmission by the consumer to the transaction controller over an independent communication channel; and
a transaction result component for receiving a transaction result from the server system of the transaction controller.

11. A method for conducting electronic payment transactions between transaction initiators and transaction responders, the method being conducted at a server system, the method comprising:
receiving, at a transaction initiation component of the server system, a transaction initiation request from transactional infrastructure of a transaction initiator, the transaction initiation request including a transaction initiator identifier and parameters of a transaction to be concluded between the transaction initiator and one or more transaction responders, the transaction initiation request excluding transaction responder specific information;
creating, by way of a token generation component of the server system, a first, responder independent, token representing the transaction;
storing the first token in a database associated with the server system;
communicating, by way of a communication component of the server system, the first token to the transactional infrastructure of the transaction initiator;
receiving, by way of a transaction response component of the server system, a transaction response request from the transactional infrastructure of at least one transaction responder, the transaction response request including a responder identifier and a second token;
comparing, by way of a token comparator component of the server system, the first and second tokens; and
settling, by way of a transaction settlement component of the server system, the transaction between the transaction initiator and transaction responder if the first and second tokens are found by the token comparator to correspond.

12. The method as claimed in claim 11, further comprising:
customising and deploying an interface component to the architectural infrastructure of each of the transaction initiators and transaction responders, the interface component providing user interfaces enabling transaction initiators to communicate transaction initiation requests to the transaction initiation component, and transaction responders to communicate transaction response requests to the transaction response component.

13. The method as claimed in claim 11, further comprising encrypting and decrypting communication between the server system and interface components by way of an encryption/decryption component.

14. The method as claimed in claim 13, further comprising:
responsive to the first and second tokens being found by the token comparator to correspond, compiling a payment confirmation message by way of a payment confirmation component, the payment confirmation message including at least some of the parameters of the transaction to be concluded;
forwarding the payment confirmation message to the encryption/decryption component of the server system for encryption and onward transmission to the interface component of the transaction responder corresponding to the responder identifier included in the second token;
receiving a payment confirmation or rejection message from the interface component of the transaction responder, the payment confirmation or rejection message including the transaction responder's confirmation or rejection of the transaction; and
compiling and transmitting a transaction approval messages to the interface components of the transaction initiator and responder transactional infrastructure if the payment confirmation or rejection messaged includes a confirmation of the transaction.

15. A method for conducting electronic payment transactions between transaction initiators and transaction responders, the method being conducted at a transaction server of a transaction initiator, the method comprising:
compiling, by way of a transaction initiation component of the transaction server, a transaction initiation request including a transaction initiator identifier and parameters of a transaction to be concluded between the transaction initiator and one or more transaction responders, the transaction initiation request excluding any transaction responder specific information;
transmitting, by way of a communication component, the transaction initiation request to a server system of a transaction controller;
receiving a first, responder independent, token representing the transaction, from the server system of the transaction controller;
conveying, by way of a token conveying component of the transaction server, the first token to a consumer for onward transmission by the consumer to the transaction controller over an independent communication channel; and
receiving, by way of a transaction result component, a transaction result from the server system of the transaction controller.

16. A computer program product, the computer program product comprising a computer readable storage medium having stored thereon computer-readable program code that when executed is configured to carry out a method for conducting electronic payment transactions between transaction initiators and transaction responders, the method comprising:
receiving a transaction initiation request from transactional infrastructure of a transaction initiator, the transaction initiation request including a transaction initiator identifier and parameters of a transaction to be concluded between the transaction initiator and one or more transaction responders, the transaction initiation request excluding any transaction responder specific information;
creating a first, responder independent, token representing the transaction;
storing the first token in a database associated with the server system;
communicating the first token to the transactional infrastructure of the transaction initiator;
receiving a transaction response request from transactional infrastructure of at least one transaction responder, the transaction response request including a responder identifier and a second token;
comparing the first and second tokens; and
settling the transaction between the transaction initiator and transaction responder if the first and second tokens are found by the token comparator to correspond.

17. A computer program product, the computer program product comprising a computer readable storage medium having stored thereon computer-readable program code that when executed is configured to carry out a method for conducting electronic payment transactions between transaction initiators and transaction responders, the method comprising:
compiling a transaction initiation request including a transaction initiator identifier and parameters of a transaction to be concluded between the transaction initiator and one or more transaction responders, the transaction initiation request excluding any transaction responder specific information;
transmitting the transaction initiation request to a server system of a transaction controller;
receiving a first, responder independent, token representing the transaction, from the server system of the transaction controller;
conveying the first token, in printed, electronic or other format, to a consumer, for onward transmission by the consumer to the transaction controller over an independent communication channel; and
receiving a transaction result from the server system of the transaction controller.
